(19) United States
(12) Patent Application Publication
(10) Pub. No.: US 2004/0181594 A1
(43) Pub. Date: Sep. 16, 2004

(54) Methods for assigning performance specifications to a storage virtual channel

(75) Inventor: Yaser I. Suleiman, Santa Clara, CA (US)

Correspondence Address: MARTINE & PENILLA, LLP, 710 LAKEWAY DRIVE, SUITE 170, SUNNYVALE, CA, 94085, US

(73) Assignee: Sun Microsystems, Inc., Santa Clara, CA

(21) Appl. No.: 10/390,512

(22) Filed: Mar. 14, 2003

(51) Int. Cl. G06F 15/16; G06F 15/173

(52) U.S. Cl. 709/225; 709/232

(57) ABSTRACT

Broadly speaking, methods are provided to allow clients to have differentiated and protected access to a shared storage resource. More specifically, a total bandwidth capability of a storage resource is divided among a number of storage virtual channels (SVCs). Each SVC can serve one or more clients requiring access to the storage resource. Each SVC is assigned performance specifications to accommodate a storage resource bandwidth access need of clients served by the SVC. The assigned performance specifications can address each bandwidth characteristic. Also, metrics corresponding to the assigned performance specifications can be used to monitor and control the SVCs. In this manner, the SVCs ensure that each client continuously receives differentiated, adequate, and protected access to the shared storage resource.

### CROSS REFERENCE TO RELATED APPLICATIONS

This application is related to U.S. patent application Ser. No. ______ (Attorney Docket No. SUNMP236), filed on even date herewith, and entitled “Storage Virtual Channels and Method for Using the Same.” The disclosure of this related application is incorporated herein by reference.

### BACKGROUND OF THE INVENTION

1. Field of the Invention

The present invention relates generally to computer storage systems, and more particularly, to methods for facilitating the sharing of a common storage resource and its bandwidth among a number of client computer platforms.

2. Description of the Related Art

An increase in single storage system capacity, as disk drive capacity is being periodically increased, enhances the ability of a fewer number of storage systems to simultaneously support the needs of different applications executing across numerous client computing platforms (“clients”). In following, Storage Area Networks (SANs) are increasingly being deployed, wherein a single storage system is tasked to provide services to multiple clients. As a result, the resources of the single storage system are increasingly becoming shared concurrently among all of its active clients. The resources of the single storage system are typically orchestrated in a fashion which maximizes the aggregate utilization of the storage system, with little or no regard to the specific needs of its individual clients.

In the current situation in which multiple clients access a single storage device, the storage devices, storage networks, and host input/output (“IO”) driver stacks all treat IO requests originating from different clients on the basis of first-come-first-serve sharing. Thus, all IO requests received by the storage device are processed in the order in which they arrive at the storage device. Hence, there is no differentiation between the clients when accessing the storage device. Also, there is no access protection afforded to the various clients accessing the storage device.

The lack of differentiation between clients when accessing the single storage device can cause problems for clients that require different performance characteristics from the storage device. For example, streaming and multimedia applications often require a steady rate of large data transmissions. Conversely, direct data accounting tends to have more random transmissions of smaller amounts of data and requires a fast response time. Other applications like file systems, databases, snapshot, and mirroring also have their own storage performance needs. Therefore, since the current storage systems lack an ability to differentiate between clients and their respective application needs, a high probability exists that at least some of a diverse group of clients will not be properly serviced by the storage device.

The lack of access protection afforded to the various clients can lead to a domination of storage device access by some clients at the expense of storage device access of other clients. Correspondingly, if a first client has an ability to generate IO requests faster than a second client, a potential exists for the first client to dominate the IO bandwidth of the storage device and drive the second client to near IO starvation. Thus, unconstrained storage resource allocations to some clients can result in unexpected degraded service to other clients. Consequently, the storage system needs to control the allocation of its resources in a manner that will protect its expected performance to the various clients.

Storage consolidation into large pools, capable of concurrently serving a larger client community, is becoming more popular through the deployment of SAN environments. In the future, it is expected that more clients will be sharing access, and in some cases competing for access, to a common storage resource. Thus, as storage resources are expected to serve a larger set of applications and clients there is an emerging need for these systems to provide new functionality in the areas of client differentiation and client access protection.

In view of the foregoing, there is a need for a method to assign performance specifications to a communication link between clients and a shared storage resource. The assigned performance specifications should ensure that the clients are provided with differentiated and protected access to the shared storage resource.

### SUMMARY OF THE INVENTION

Broadly speaking, the present invention fills these needs by providing methods that allow clients to have differentiated and protected access to a shared storage resource. More specifically, the present invention divides a total bandwidth capability of a storage resource among a number of storage virtual channels (SVCs). Each SVC can serve one or more clients requiring access to the storage resource. Each SVC is assigned performance specifications to accommodate a storage resource bandwidth access need of clients served by the SVC. The assigned performance specifications can address each bandwidth characteristic. Also, metrics corresponding to the assigned performance specifications can be used to monitor and control the SVCs. In this manner, the SVCs ensure that each client continuously receives differentiated, adequate, and protected access to the shared storage resource.

In one embodiment, a method for managing bandwidth access of a storage resource is disclosed. The method includes determining a total bandwidth of the storage resource. The total bandwidth is defined by a number of metrics. In one embodiment, the metrics include a throughput capability and a response time capability. The method further includes dividing the total bandwidth into a plurality of SVCs such that each SVC represents a portion of the total bandwidth. The method also includes assigning to each SVC a constant percentile of the metrics defining the total bandwidth of the storage resource. Additionally in the method, each of the SVCs are controlled to provide a client with a storage resource bandwidth access corresponding to the constant percentile of the metrics assigned to the SVC.

In another embodiment, a method for controlling a storage resource is disclosed. The method includes determining a total bandwidth of the storage resource. The total bandwidth is defined by a number of metrics. In one embodiment, the metrics include a throughput capability and a response time capability. The method further includes dividing the total bandwidth into a plurality of SVCs such that each SVC represents a portion of the total bandwidth. The method also includes assigning to each SVC a value for each metric defining the total bandwidth of the storage resource. The values for each metric can be assigned independently from one another. A particular metric can be assigned to an SVC in an arbitrary and independent manner so long as the cumulative assignment of the particular metric across all SVCs does not exceed the total bandwidth capability of the storage resource with respect to the particular metric. Additionally in the method, each of the SVCs are controlled to provide a client with a storage resource bandwidth access corresponding to each of the metrics assigned to the SVC.

In another embodiment, a method for monitoring distribution of a storage resource bandwidth is disclosed. The method includes determining a total bandwidth capability for the storage resource. The total bandwidth capability includes a throughput capability and a response time capability. The method also includes assigning a portion of the total bandwidth capability to define a SVC. The method further includes determining a performance value of the SVC. Also in the method, an aggregate performance value for a number of SVCs is determined. The aggregate performance value represents a sum of the performance values from each SVC. The method also includes determining an efficiency for the implementation of SVCs. The efficiency represents a ratio of the aggregate performance value to a total performance capability of the storage resource.

Other aspects of the invention will become more apparent from the following detailed description, taken in conjunction with the accompanying drawings, illustrating by way of example the present invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a storage area network (SAN), in accordance with one embodiment of the present invention;

FIG. 2 is an illustration showing a storage resource in communication with a SAN, in accordance with one embodiment of the present invention;

FIG. 3A is an illustration depicting a storage resource having a number of ports, wherein each port has a dedicated SVC, in accordance with one embodiment of the present invention;

FIG. 3B is an illustration depicting a storage resource having a number of ports, wherein a port can be used by multiple SVCs or a port can be dedicated to a single SVC, in accordance with one embodiment of the present invention;

FIG. 3C is an illustration depicting a storage resource having a number of LUNs, wherein a LUN can be used by multiple SVCs or a LUN can be dedicated to a single SVC, in accordance with one embodiment of the present invention;

FIG. 4 is an illustration depicting a number of clients communicating with a storage resource through a number of SVCs, in accordance with one embodiment of the present invention;

FIG. 5 is an illustration depicting a functional model of a RAID based storage resource implementing SVCs, in accordance with one embodiment of the present invention;

FIG. 6 shows a flowchart illustrating a method for managing bandwidth access of a storage resource, in accordance with one embodiment of the present invention;

FIG. 7 shows a flowchart illustrating a method for controlling a storage resource, in accordance with one embodiment of the present invention; and

FIG. 8 shows a flowchart illustrating a method for monitoring distribution of a storage resource bandwidth, in accordance with one embodiment of the present invention.

### DETAILED DESCRIPTION OF THE PREFERRED EMBODIMENTS

Broadly speaking, an invention is disclosed for a process and a method that allows clients to have differentiated and protected access to a shared storage resource. More specifically, the present invention divides a total bandwidth capability of a storage resource among a number of storage virtual channels. Each storage virtual channel can serve one or more clients requiring access to the storage resource. Each storage virtual channel is defined to accommodate an associated client's storage resource access needs. The assignment of a storage virtual channel to a client can be based on several factors including, but not limited to, a bandwidth capability of the storage virtual channel, a bandwidth need of the client, and a bandwidth privilege level of the client. The storage virtual channels ensure that each client continuously receives differentiated, adequate, and protected access to the shared storage resource. It should be appreciated that the present invention can be implemented in numerous ways, including as a process, an apparatus, a system, a device, or a method. Several exemplary embodiments of the invention will now be described in detail with reference to the accompanying drawings.

In the following description, numerous specific details are set forth in order to provide a thorough understanding of the present invention. It will be apparent, however, to one skilled in the art that the present invention may be practiced without some or all of these specific details. In other instances, well known process operations have not been described in detail in order not to unnecessarily obscure the present invention.

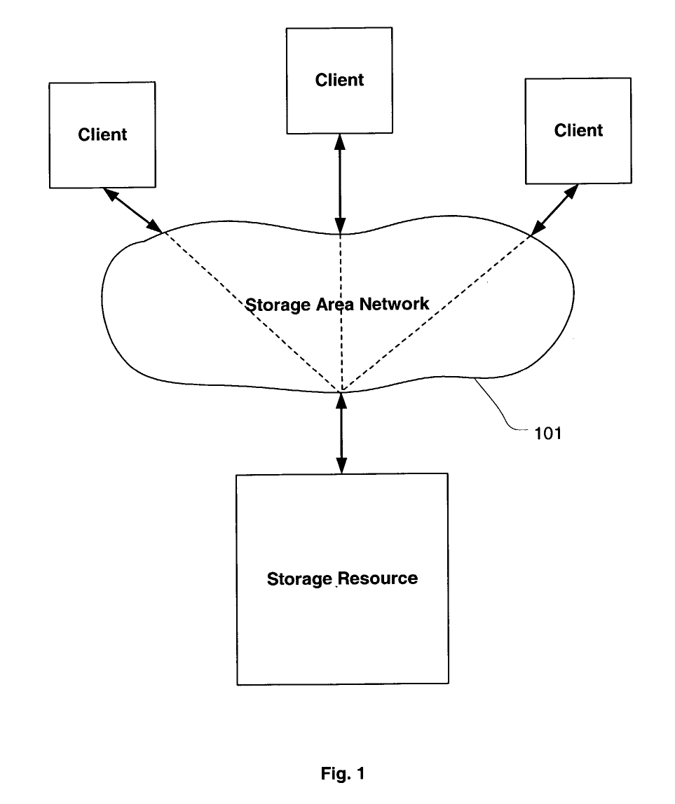

FIG. 1 is an illustration showing a storage area network (SAN) 101, in accordance with one embodiment of the present invention. The SAN 101 includes at least one client in communication with a storage resource using input/output (IO) requests. The term “clients” means any entity with an associated 10 workload, such as an application, a set of applications within one or more computer host systems, one or more ports of a client, and single or multiple clients. The storage resource includes one or more storage devices capable of storing data suitable for use by a client.

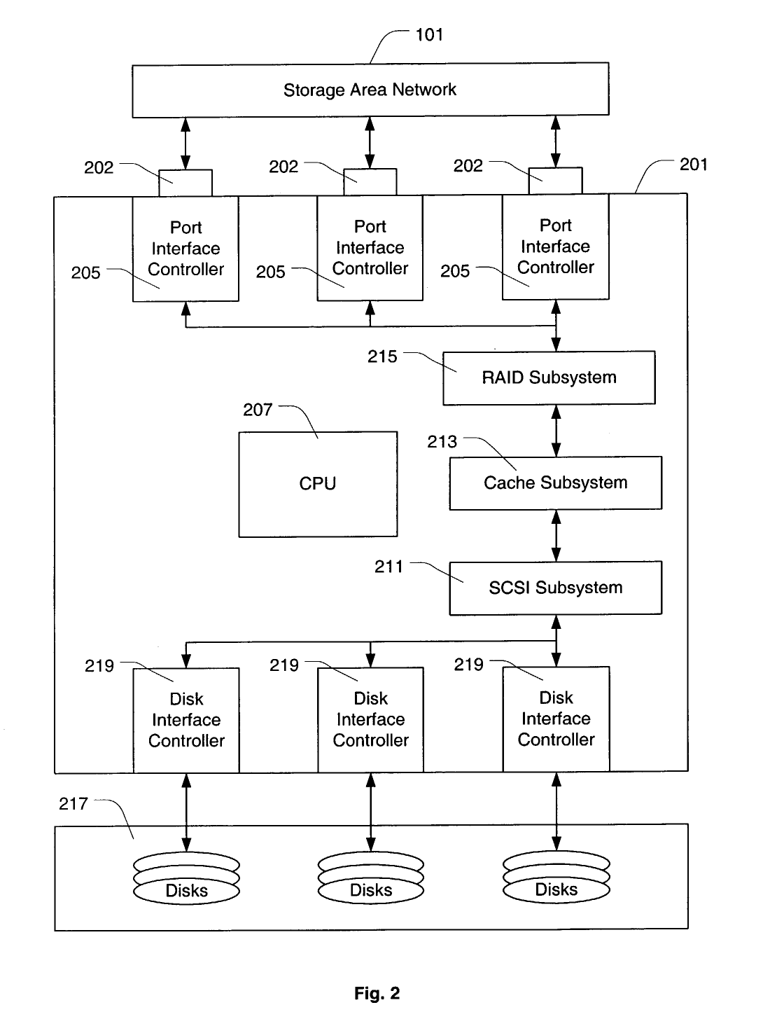

FIG. 2 is an illustration showing a storage resource 201 in communication with a SAN 101, in accordance with one embodiment of the present invention. The storage resource 201 can include one or more ports 202 through which communication with the clients of the SAN 101 is established. Each port has an associated port interface controller 205. The storage resource 201 includes a SCSI subsystem 211 for decoding and encoding IO requests from and responses to the clients of the SAN 101. A cache subsystem 213 is also provided for fast retrieval and copying of data. A RAID subsystem 215 is provided to orchestrate an array of disks 217. A number of disk interface controllers 219 are provided for interfacing with the array of disks 217. The data path flow through the storage resource 201 includes the port interface controller 205, the SCSI subsystem 211, the cache subsystem 213, the RAID subsystem 215, the disk interface controller 219, and the array of disks 217. The storage resource 201 also includes a CPU 207. The CPU 207 is used to control the operations of the storage resource 201.

Generally speaking, the clients can transmit data to the storage resource and receive data from the storage resource. Communication between the clients and the storage resource is governed by a bandwidth of the storage resource. The total bandwidth of the storage resource is defined by a throughput capability and a response time capability. Also, throughput and response time represent metrics that can be used to measure the performance of a storage system. Throughput is a measure of the rate or speed at which the storage system can deliver data. Throughput can be expressed as access rate or IO request processing rate in terms of IO per second (IO/sec). Throughput can also be expressed as a data rate in terms of megabytes delivered per second (MB/sec). The response time capability, also referred to as latency, is the average amount of time required for the storage resource to respond to a client's request. As a metric, response time is a measure of how long it takes a storage system to deliver stored data. Response time can be measured relative to delivering data to a storage system port, or for receiving data at the client, or for receiving data at the requesting application.

IO workloads are also used in combination with the throughput and response time metrics to describe storage system performance. IO workloads are used to represent specific IO demands of some applications. In general, the IO workload represents a set of IO requests initiated over a period of time. IO requests in the IO workload can be characterized by an inter-arrival time function, a request type (e.g., read or write), IO request data size (e.g., MB), and spatial order (e.g., sequential access, repeated patterns, or random access).

Different applications can possess diverse IO patterns and can be best represented by specifically formulated workloads. However, in general, applications are characterized as either requiring high throughput (i.e., MB/sec or IO/sec) or fast response time. A high MB/sec is associated with applications which generate fewer IO requests but demand large amounts of data. A fast response time is associated with applications which generate short requests (e.g., online transaction applications).

As storage system utilization increases, the storage system throughput also increases and approaches an asymptotic maximum. The performance metrics of throughput (MB/sec and IO/sec) and response time are not completely independent. For example, response time and throughput in IO/sec are inversely related. Also, as the delivered MB/sec increases so does the average response time, while 10/sec simultaneously decreases.

The total bandwidth capability of a storage resource can be divided into a number of smaller bandwidths, wherein each smaller bandwidth is assigned to a storage virtual channel (SVC). Each SVC can be independently controlled to provide clients with differentiated and protected access to the storage resource. In this manner, an SVC can be used to supply a specific storage performance level (i.e., throughput and response time) to a client to which the SVC is assigned. Additionally, the specific storage performance level supplied by an SVC is protected from degradation that may be caused by other SVC workloads. Thus, the SVC provides a mechanism for sharing the resources of a single storage system concurrently between multiple clients, wherein each client receives protected and expected performance from the storage system.

The creation of SVCs can be performed either manually or automatically based on a preset policy. SVCs are defined to accommodate various aspects of the client's privilege level and bandwidth requirements. SVCs can be set to guarantee minimum bandwidth, and/or to limit the maximum bandwidth based on the client privilege level. The client bandwidth need and client privilege level can be characterized in terms of MB/sec, IO/sec, response time, and any combination thereof. Each SVC is dynamic in the sense that each SVC can be created, modified, and destroyed as needed. In one embodiment, SVCs are destroyed when no longer needed, thus freeing up their bandwidth for use by other existing SVCs. For example, an SVC may be created for a client when the client is present in the SAN. However, when the client leaves the SAN or is no longer in communication with the SAN, the corresponding SVC bandwidth can be reconstituted into the free bandwidth available for use by other SVCs.

Each SVC is independently assigned to serve one or more clients. In one embodiment, the assignment of SVCs to clients is based on a policy set by an administrator. The policy can consider pertinent factors such as client bandwidth need, client privilege level, and bandwidth afforded by the SVC. In another embodiment, SVCs may be assigned or reassigned based on performance levels. For example, if an SVC is assigned to one client that only uses a small portion of the bandwidth afforded by the SVC. The SVC may also be assigned to another client having a commensurate client bandwidth need and client privilege level. In addition to being assigned to external clients, each SVC can also be assigned to internal entities such as a port of the storage resource or a logical unit number (LUN) of the storage resource. In this instance, any client using the port or accessing the LUN will be served by the SVC assigned to the respective port or LUN.

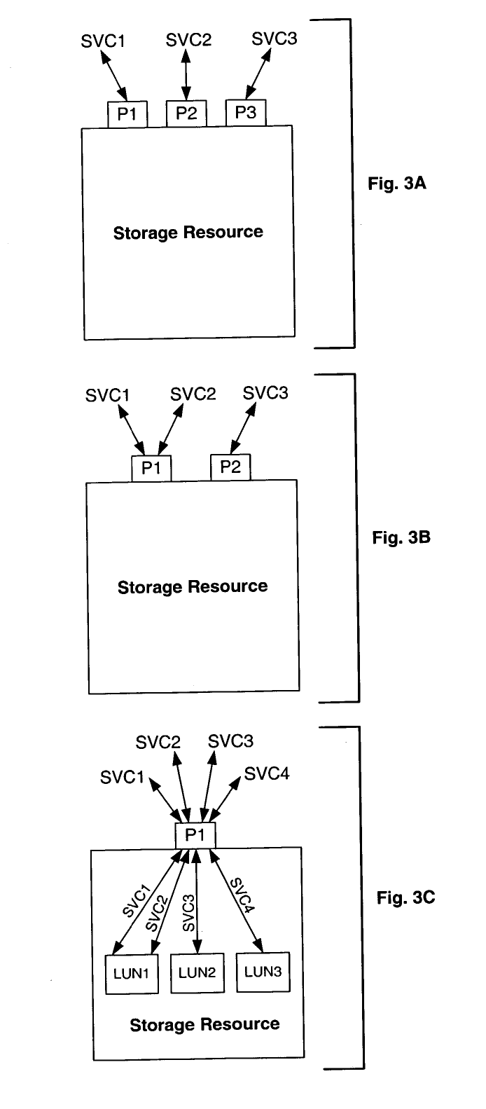

FIG. 3A is an illustration depicting a storage resource having a number of ports, wherein each port has a dedicated SVC, in accordance with one embodiment of the present invention. The storage resource is shown as having ports P1, P2, and P3. SVCs SVC1, SVC2, and SVC3 use ports P1, P2, and P3, respectively.

FIG. 3B is an illustration depicting a storage resource having a number of ports, wherein a port can be used by multiple SVCs or a port can be dedicated to a single SVC, in accordance with one embodiment of the present invention. The storage resource is shown as having ports P1 and P2. SVC1 and SVC2 use port P1, and SVC3 uses port P2.

FIG. 3C is an illustration depicting a storage resource having a number of LUNs, wherein a LUN can be used by multiple SVCs or a LUN can be dedicated to a single SVC, in accordance with one embodiment of the present invention. SVC1, SVC2, SVC3, and SVC4 share port P1. However, SVC1 and SVC2 are assigned to LUN1 while SVC3 and SVC4 are assigned to LUN2 and LUN3, respectively.

The embodiments depicted in FIGS. 3A through 3C are provided for exemplary purposes. Other embodiments can include different numbers of SVCs, ports, and LUNs. Furthermore, other embodiments can have the various SVCs assigned to the ports and LUNs in different ways.

Differentiated performance levels are provided to the different clients by assigning an SVC having appropriate specifications to each client. Determination of an appropriate SVC specification for a client can be based on a privilege level associated with the client. The client privilege level can be characterized by a required minimum throughput and/or a maximum allowable response time.

Assignment of an SVC to a client is a flexible operation. For example, an SVC can be assigned to a single client to serve only the storage workload of that client. Alternatively, an SVC can be assigned to multiple clients to serve the storage workloads of the multiple clients. If an SVC is exclusively assigned to a client, the bandwidth afforded by the SVC can be expected by the client. If multiple clients share an SVC, the bandwidth afforded by the SVC is distributed among the storage workloads of the multiple clients. In one embodiment, multiple clients sharing the SVC will compete on a first-come-first-serve basis. Consequently in this embodiment, multiple clients sharing the SVC may experience fluctuations in their storage performance based on other client storage workload variations. In another embodiment, the bandwidth afforded by the SVC can be sub-divided in a hierarchical manner to create sub-SVCs capable of serving the multiple clients. In this embodiment, each of the multiple clients will be guaranteed a storage performance corresponding to the characteristics of the assigned sub-SVC.

In addition to being assigned independently, each SVC can also be independently controlled. Since each SVC is defined in terms of the bandwidth parameters throughput and response time, it follows that each SVC can be controlled in terms of throughput and response time. For example, an SVC can be controlled to operate within ranges extending from minimum MB/sec, minimum IO/sec, and minimum response time to maximum MB/sec, maximum IO/sec, and maximum response time, respectively.

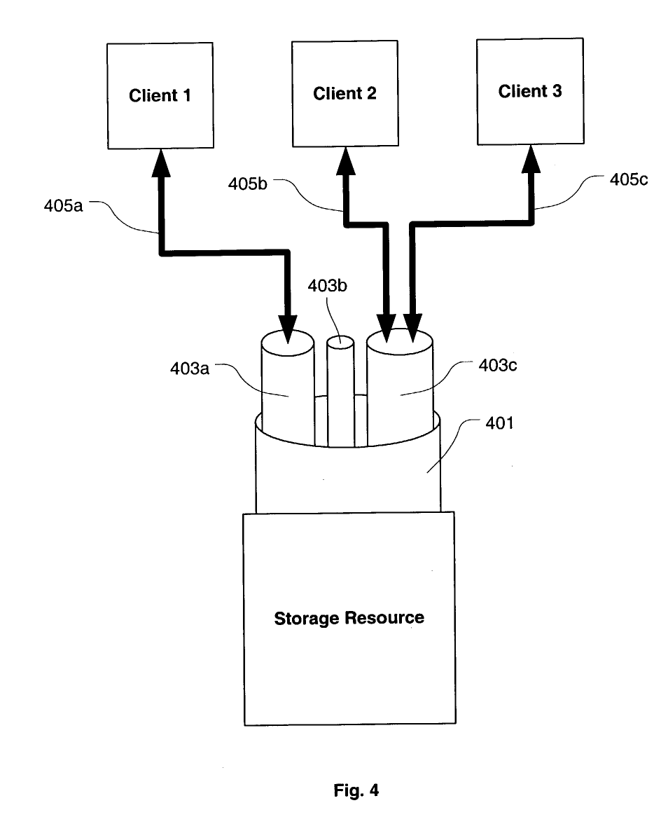

FIG. 4 is an illustration depicting a number of clients communicating with a storage resource through a number of SVCs, in accordance with one embodiment of the present invention. For exemplary purposes, three clients, Client 1, Client 2, and Client 3, are shown communicating with the storage resource through two of three SVCs, 403a, 403b, and 403c. SVCs 403a, 403b, and 403c each represent a portion of the total bandwidth 401 offered by the storage resource. Communication, as indicated by arrow 405a, is established between Client 1 and the storage resource through SVC 403a. Also, communications, as indicated by arrows 405b and 405c, are established between Client 2 and Client 3, respectively, and the storage resource through SVC 403c. In one embodiment, since both Client 2 and Client 3 share SVC 403c, Client 2 and Client 3 operate on a first-come-first-serve basis with respect to the bandwidth offered by SVC 403c. In the example of FIG. 4, SVC 403b is not connected to a client. In one embodiment SVC 403b may be held in reserve for future use as needed. In another embodiment, SVC 403b may be dedicated to a particular client that is not currently present.

Each SVC provides its assigned clients with a minimum guaranteed storage resource bandwidth. Thus, each SVC protects its assigned clients from being adversely impacted by concurrent loads placed on the storage resource by other clients. In order to provide the minimum guaranteed storage resource bandwidth, the various SVCs are allowed to limit their clients to a maximum storage resource bandwidth. The maximum storage resource bandwidth of an SVC must be at least as large as the minimum storage resource bandwidth guaranteed by the SVC. However, the maximum storage resource bandwidth of each SVC can be limited to allow all SVCs to provide at least the minimum storage resource bandwidth guaranteed to their clients.

Each SVC has an associated performance value (P_{SVC}). There is no theoretical limitation on the number of SVCs created. However, an aggregate of all SVC performance values (P_{AGGREGATE}) must be equal to or less than a total performance of the storage system (P_{TOTAL}). An efficiency of an SVC implementation (E_{SVC}) can be determined by dividing P_{AGGREGATE} by P_{TOTAL}: E_{SVC}=(P_{AGGREGATE}/P_{TOTAL}).

The metrics of throughput (MB/sec and IO/sec) and response time can be used as performance specifications when defining SVCs. In one embodiment, any single SVC can be assigned a constant percentile of the total storage system performance for all metrics. For example, assigning 20% of the total performance to an SVC indicates that the expected performance of the SVC, in terms of MB/sec, IO/sec, and response time, is identical to that of the total storage system performance multiplied by one-fifth. Other SVCs can be assigned additional percentiles until the sum of all percentiles represents 100% of the total storage system performance.

In another embodiment, arbitrary values for each metric can be assigned to an SVC. For example, an SVC may be assigned 20% in terms of MB/sec and 30% in terms of IO/sec of the total storage system performance. Additionally, a response time metric can also be assigned to the SVC. Since the MB/sec, IO/sec, and response time metrics are dependent upon one another, the metrics for all SVCs are concurrently managed to ensure that each SVC receives its assigned minimum performance specifications at all times. In one example, the control specifications can be assigned to each of the defined SVCs assuming that all SVCs are continuously serving clients at full capacity. In another example, the control specifications can be assigned to each of the defined SVCs based on assumed average workloads that each SVC is expected to experience.

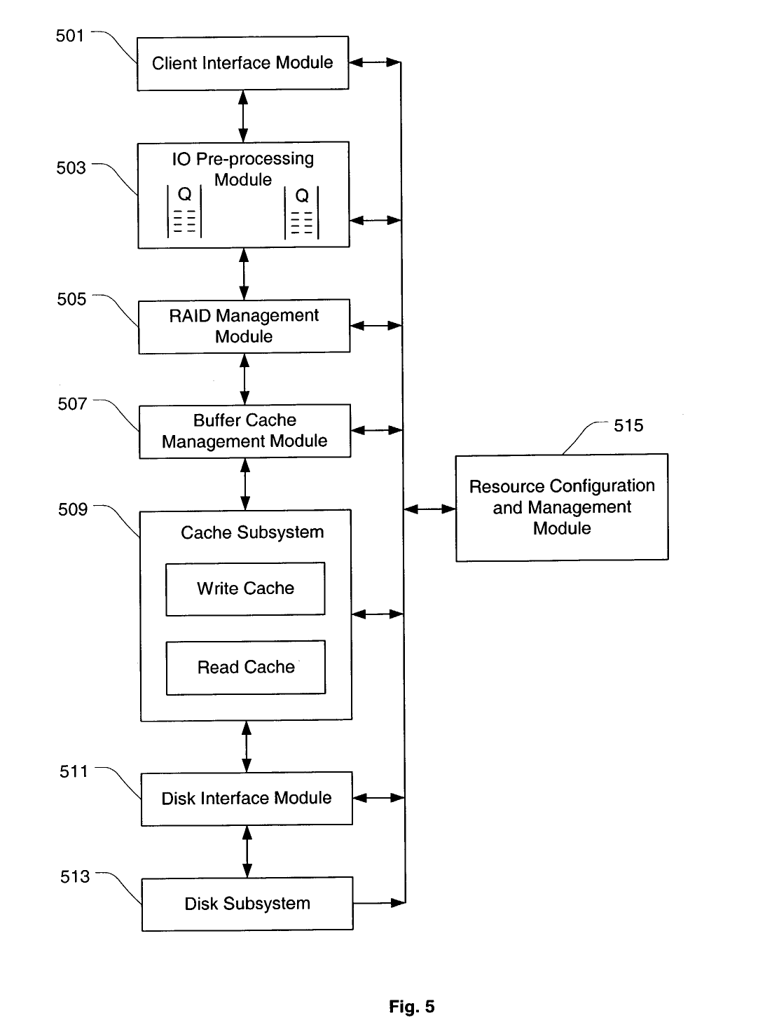

SVCs can be implemented in a variety of storage systems which utilize modern storage interface protocols. For exemplary purposes only, a discussion of SVC implementation in a RAID based storage resource using a SCSI protocol is provided below. FIG. 5 is an illustration depicting a functional model of a RAID based storage resource implementing SVCs, in accordance with one embodiment of the present invention. A client interface module 501 is provided to receive a data transfer command from a client, implement a protocol engine, extract a storage system command, and pass the storage system command to a IO pre-processing module 503. SCSI (small computer system interface) is the protocol engine of many current storage systems. SCSI is a block IO standard which incorporates both a set of protocols for the exchange of block IO data between clients and storage resources, and a parallel bus architecture. In addition, the present invention applies to other kinds of SCSI transports such as Fibre Channel (FCP) and TCP/IP iSCSI. In SCSI, the client invokes the IO commands, and the storage resource is responsible for directing movements of block data. Thus, whenever the client sends a SCSI command to the storage resource requesting data, the client waits while the storage resource processes the command. In following, the SCSI protocol allows clients to queue multiple commands. However, the SCSI protocol does not dictate a specific queuing technique. The specific queuing technique must be implemented within the storage resource. Though this example of SVC implementation is presented in terms of a SCSI protocol and a RAID based storage system, it should be appreciated that SVCs can be implemented with any storage system using any storage interface protocol suitable for use in a SAN environment.

Upon receipt of the command in the IO pre-processing module 503, the command is queued and decoded for further processing. A first level of SVC implementation can be provided in the IO pre-processing module 503. For example, each SVC can be assigned to a separate queue. Thus, all commands received through a given SVC will be stacked in a given queue. Each queue can then be weighted based on the SVC specifications of throughput and response time. In this manner, commands can be scheduled for processing from the various queues in a sequence that preserves the storage resource bandwidth guaranteed by the various SVCs to their respective clients. Hence, with SVC implementation, the queues in the IO pre-processing module 503 can be referred to as scheduling queues. In one embodiment, the various scheduling queues can be created by firmware of the storage resource. In following, the weighting of the scheduling queues and the orchestration of command processing from the various scheduling queues can be controlled using a scheduling algorithm that controls the corresponding firmware of the storage resource. In one embodiment, each of the scheduling queues can be represented as a separate portion of cache. Thus, each SVC can be assigned to a separate cache that is created by the storage resource firmware.

Once an appropriate command is selected from the various scheduling queues according to the scheduling algorithm, the RAID management module 505 is responsible for decomposing the command into one or more stripe operations. Each stripe operation specifies a set of IO operations to be performed on either the disk subsystem and/or cache buffer corresponding to the stripe. In one possible SVC implementation, the RAID management module 505 can optionally be configured to have a separate cache corresponding to each scheduling queue (i.e., a SVC). The stripe operations can be queued into the cache corresponding the scheduling queue from which their originating command was received. A cache selector can then be employed to direct the sequence in which stripe operation will be selected for execution from the various caches. The cache selector can operate based on an algorithm similar to that used for the scheduling algorithm in the IO pre-processing module 503. In this manner, the cache and cache selector within the RAID management module 505 can act a second level of SVC implementation to provide redundancy in ensuring that the storage resource bandwidth guaranteed by the various SVCs is provided to their respective clients.

Once the cache selector selects a stripe operation to be executed, the stripe operation is processed through the remaining standard functional modules of the RAID based storage resource including a buffer cache management module 507, a cache subsystem 509, a disk interface module 511, and the disk subsystem 513. Generally speaking, the buffer cache management module 507 is responsible for allocating buffers and orchestrating the cache allocation and replacement policy within the cache subsystem 509. The cache subsystem 509 contains a write cache and a read cache. From the cache subsystem 509 the various stripe operations are passed to the disk interface module 511 where a set of corresponding disk commands is generated. A disk command is simply a SCSI read or SCSI write for an amount of data in one stripe unit. The disk commands are passed from the disk interface module 511 to the disk subsystem 513 where they are ultimately executed. Data resulting from execution of the disk commands is then transferred between the cache subsystem 509 and the disk subsystem 513.

The functional model of the RAID based storage resource implementing SVCs also includes a resource configuration and management module 515. The resource configuration and management module 515 traditionally handles tasks such as configuration and management of volumes, LUNs, read cache size, write cache size, and stripe size. However, with implementation of SVCs, the resource configuration and management module 515 can also be used to implement the scheduling and cache selector algorithms.

Thus, in accordance with the example above, the SVCs can be enforced at a first level using scheduling queues and a scheduling algorithm, wherein each SVC is assigned to a separate scheduling queue. The scheduling algorithm is used to control the sequence in which commands contained within the scheduling queues are processed. The scheduling algorithm operates based on weightings of the various scheduling queues. The weightings of the various scheduling queues are a function of the corresponding SVC specifications of throughput and response time. The SVCs can be further enforced at a second level using multiple caches and a cache selector, wherein each of the multiple caches corresponds to a scheduling queue (i.e., SVC). In a manner similar to the scheduling algorithm, the cache selector is used to control the sequence in which stripe operations contained within the caches are further processed. Hence, in one embodiment SVCs can be implemented using techniques of multiple scheduling queues, a scheduling algorithm, multiple caches, and a cache selector. It should be understood, however, that SVC implementation is not limited to the aforementioned techniques.

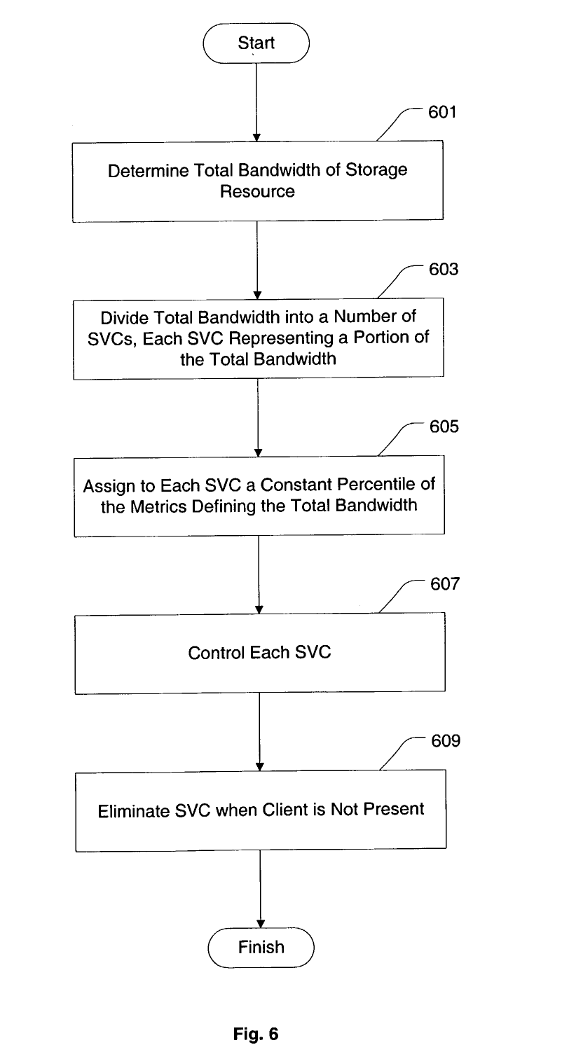

FIG. 6 shows a flowchart illustrating a method for managing bandwidth access of a storage resource, in accordance with one embodiment of the present invention. The method includes an operation 601 for determining a total bandwidth of the storage resource. The total bandwidth is defined by a number of metrics. In one embodiment, the metrics include a throughput capability and a response time capability. The throughput capability is measured in megabytes delivered per second and IO requests performed per second. The method further includes an operation 603 for dividing the total bandwidth into a number of SVCs such that each SVC represents a portion of the total bandwidth. The method also includes an operation 605 for assigning to each SVC a constant percentile of the metrics defining the total bandwidth of the storage resource. For example, consider an example SVC that is assigned a constant percentile of the metrics defining the total bandwidth of the storage resource. In this example, each of the metrics defining the total bandwidth of the storage resource are assigned to the SVC based on a common percentage (e.g., 40% of the storage resource MB/sec is assigned to the SVC, 40% of the storage resource IO/sec is assigned to the SVC, and 40% of the storage resource response time is assigned to the SVC). In one embodiment, the constant percentile is based on a client bandwidth need and a client privilege level. The client privilege level is defined by an allowable minimum throughput and an allowable maximum response time. Additionally in an operation 607 of the method, each of the SVCs are controlled to provide a client with a storage resource bandwidth access corresponding to the constant percentile of the metrics assigned to the SVC. The client is an entity having an associated IO workload. In some circumstances, the storage resource may have excess bandwidth that is not used or not assigned to an SVC. When excess bandwidth is available, the SVCs can be controlled to provide the client with a storage resource bandwidth access exceeding the constant percentile of the metrics assigned to the SVC. In other circumstances, the storage resource may be fully utilized such that the throughput capability of each SVC must be controlled in a limiting manner to ensure that each client will receive at least the storage resource bandwidth access corresponding to the constant percentile of the metrics assigned to the associated SVC. In one embodiment, the method can also include an operation 609 for eliminating a SVC when a client is not present for the SVC to serve. When a SVC is eliminated, the bandwidth assigned to the eliminated SVC can be reconstituted to be made available to other existing SVCs.

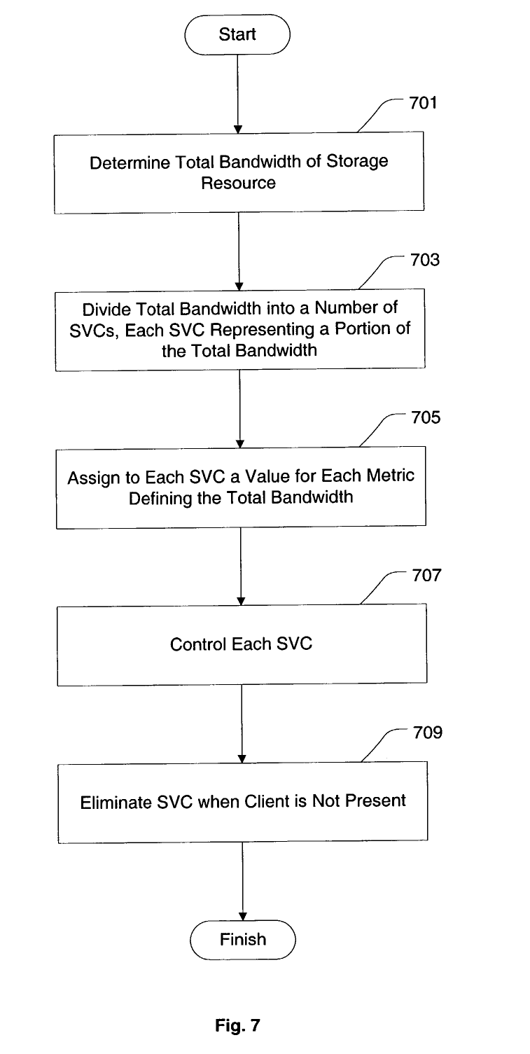

FIG. 7 shows a flowchart illustrating a method for controlling a storage resource, in accordance with one embodiment of the present invention. The method includes an operation 701 for determining a total bandwidth of the storage resource. The total bandwidth is defined by a number of metrics. In one embodiment, the metrics include a throughput capability and a response time capability. The throughput capability is measured in megabytes delivered per second and IO requests performed per second. The method further includes an operation 703 for dividing the total bandwidth into a number of SVCs such that each SVC represents a portion of the total bandwidth. The method also includes an operation 705 for assigning to each SVC a value for each metric defining the total bandwidth of the storage resource. The values for each metric can be assigned independently from one another. For example, a first SVC can be assigned metrics of 40% MB/sec, 40% IO/sec, and 20% response time to characterize the bandwidth defining the SVC. Continuing with the example, a second SVC can be assigned metrics of 20% MB/sec, 70% IO/sec, and 10% response time to characterize the bandwidth defining the SVC. Therefore, a particular metric can be assigned to an SVC in an arbitrary and independent manner so long as the cumulative assignment of the particular metric across all SVCs does not exceed the total bandwidth capability of the storage resource with respect to the particular metric. In one embodiment, the assignment of each metric to an SVC is based on a bandwidth need and a privilege level of a client to which the SVC will serve, wherein the client is an entity having an associated IO workload. The client privilege level is defined by an allowable minimum throughput and an allowable maximum response time. Additionally in an operation 707, each of the SVCs are controlled to provide a client with a storage resource bandwidth access corresponding to each of the metrics assigned to the SVC. In some circumstances, the storage resource may have excess bandwidth that is not used or not assigned to an SVC. When excess bandwidth is available, the SVCs can be controlled to provide the client with a storage resource bandwidth access exceeding the metrics assigned to the SVC. In other circumstances, the storage resource may be fully utilized such that the throughput capability of each SVC must be controlled in a limiting manner to ensure that each client will receive at least the storage resource bandwidth access corresponding to the metrics assigned to the associated SVC. In one embodiment, the method can also include an operation 709 for eliminating a SVC when a client is not present for the SVC to serve. When a SVC is eliminated, the bandwidth assigned to the eliminated SVC can be reconstituted to be made available to other existing SVCs.

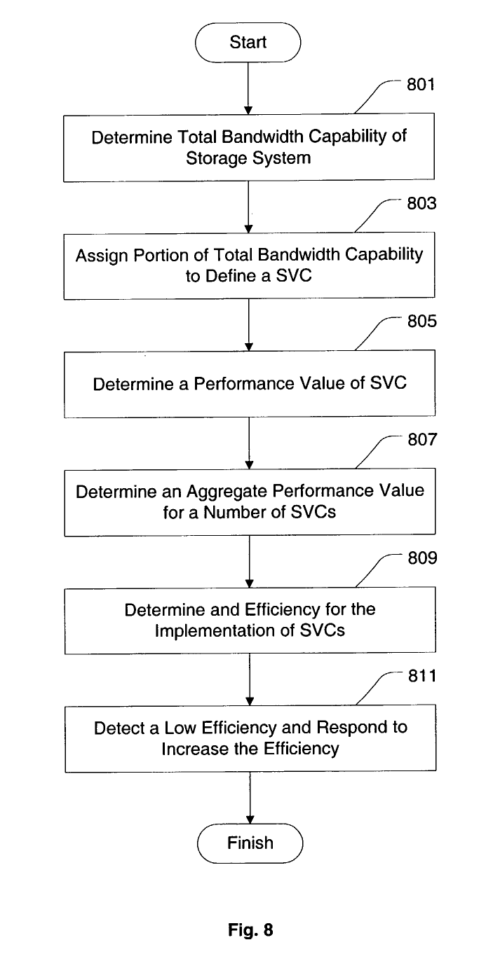

FIG. 8 shows a flowchart illustrating a method for monitoring distribution of a storage resource bandwidth, in accordance with one embodiment of the present invention. The method includes an operation 801 for determining a total bandwidth capability for the storage resource. The total bandwidth capability includes a throughput capability and a response time capability, wherein the throughput capability is measured in megabytes delivered per second and IO requests performed per second. The method also includes an operation 803 for assigning a portion of the total bandwidth capability to define a SVC. The assigned portion of the total bandwidth capability is based on a need and a privilege level of a client to which the SVC will serve. The method further includes an operation 805 for determining a performance value of the SVC. Examples of performance values include actual megabytes delivered per second, actual IO requests performed per second, and an actual average response time, among others. Also in an operation 807 of the method, an aggregate performance value for a number of SVCs is determined. The aggregate performance value represents a sum of the performance values from each SVC. The method also includes an operation 809 for determining an efficiency for the implementation of SVCs. The efficiency represents a ratio of the aggregate performance value to a total performance capability of the storage resource. The method can also include an operation 811 for detecting a low efficiency and responding to increase the efficiency. In one embodiment, the response to increase the efficiency can include adjusting the portion of the total bandwidth assigned to an SVC whose performance values are not optimal. In another embodiment, the response to increase the efficiency can include reassigning the portion of the total bandwidth assigned to the SVC whose performance values are optimal to another SVC. In following, clients assigned to the SVC having non-optimal performance values will be reassigned to other SVCs capable of satisfying the storage resource bandwidth access needs of the clients.

While this invention has been described in terms of several embodiments, it will be appreciated that those skilled in the art upon reading the preceding specifications and studying the drawings will realize various alterations, additions, permutations and equivalents thereof. It is therefore intended that the present invention includes all such alterations, additions, permutations, and equivalents as fall within the true spirit and scope of the invention.

What is claimed is:

1. A method for managing bandwidth access of a storage resource, comprising:
determining a total bandwidth of the storage resource, wherein the total bandwidth is defined by a number of metrics;
dividing the total bandwidth into a plurality of storage virtual channels, each of the plurality of storage virtual channels representing a portion of the total bandwidth;
assigning to each of the plurality of storage virtual channels a constant percentile of the metrics defining the total bandwidth of the storage resource; and
controlling each of the plurality of storage virtual channels to provide a client with a storage resource bandwidth access corresponding to the assigned constant percentile of the metrics defining the total bandwidth of the storage resource.

2. A method for managing bandwidth access of a storage resource as recited in claim 1, wherein the metrics include a throughput capability and a response time capability.

3. A method for managing bandwidth access of a storage resource as recited in claim 2, wherein the throughput capability is measured in megabytes delivered per second and input/output requests performed per second.

4. A method for managing bandwidth access of a storage resource as recited in claim 1, wherein the constant percentile is based on a client bandwidth need and a client privilege level.

5. A method for managing bandwidth access of a storage resource as recited in claim 4, wherein the client privilege level is defined by an allowable minimum throughput and an allowable maximum response time.

6. A method for managing bandwidth access of a storage resource as recited in claim 1, wherein the client is an entity having an associated input/output workload.

7. A method for managing bandwidth access of a storage resource as recited in claim 1, wherein the controlling includes providing the client with a storage resource bandwidth access exceeding the assigned constant percentile of the metrics when possible based on available storage resource bandwidth.

8. A method for managing bandwidth access of a storage resource as recited in claim 1, wherein the controlling includes limiting a throughput capability of each of the plurality of storage virtual channels to ensure that the client will receive the storage resource bandwidth access corresponding to the assigned constant percentile.

9. A method for managing bandwidth access of a storage resource as recited in claim 1, further comprising:
eliminating a storage virtual channel when the client is not present.

10. A method for managing bandwidth access of a storage resource as recited in claim 9, further comprising:
reconstituting the bandwidth of the storage resource assigned to the storage virtual channel, wherein the reconstituted bandwidth is made available to other storage virtual channels.

11. A method for controlling a storage resource, comprising:
determining a total bandwidth of the storage resource, wherein the total bandwidth is defined by a number of metrics;
dividing the total bandwidth into a plurality of storage virtual channels, each of the plurality of storage virtual channels representing a portion of the total bandwidth;
assigning to each of the plurality of storage virtual channels a value for each metric defining the total bandwidth of the storage resource, the value for each metric being assigned independently; and
controlling each of the plurality of storage virtual channels to provide a client with a storage resource bandwidth access corresponding to the assigned value for each metric defining the total bandwidth of the storage resource.

12. A method for controlling a storage resource as recited in claim 11, wherein the metrics include a throughput capability and a response time capability.

13. A method for controlling a storage resource as recited in claim 12, wherein the throughput capability is measured in megabytes delivered per second and input/output requests performed per second.

14. A method for controlling a storage resource as recited in claim 11, wherein the assigned value for each metric is based on a client bandwidth need and a client privilege level.

15. A method for controlling a storage resource as recited in claim 14, wherein the client privilege level is defined by an allowable minimum throughput and an allowable maximum response time.

16. A method for controlling a storage resource as recited in claim 11, wherein the client is an entity having an associated input/output workload.

17. A method for controlling a storage resource as recited in claim 11, wherein the controlling includes providing the client with a storage resource bandwidth access exceeding the assigned value for each metric when possible based on available storage resource bandwidth.

18. A method for controlling a storage resource as recited in claim 11, wherein the controlling includes limiting a throughput capability of each of the plurality of storage virtual channels to ensure that the client will receive the storage resource bandwidth access corresponding to the assigned value for each metric.

19. A method for controlling a storage resource as recited in claim 11, further comprising:
eliminating a storage virtual channel when the client is not present.

20. A method for controlling a storage resource as recited in claim 11, further comprising:
reconstituting the bandwidth of the storage resource assigned to the storage virtual channel, wherein the reconstituted bandwidth is made available to other storage virtual channels.

21. A method for monitoring distribution of a storage resource bandwidth, comprising:
determining a total bandwidth capability for the storage resource;
assigning a portion of the total bandwidth capability to define a storage virtual channel;
determining a performance value of the storage virtual channel;
determining an aggregate performance value for a plurality of storage virtual channels, the aggregate performance value representing a sum of the performance values from each storage virtual channel in the plurality of storage virtual channels; and
determining an efficiency for the implementation of storage virtual channels, the efficiency representing a ratio of the aggregate performance value to a total performance capability of the storage resource.

22. A method for monitoring distribution of a storage resource bandwidth as recited in claim 21, further comprising:
detecting a low efficiency; and
adjusting the portion of the total bandwidth assigned to the storage virtual channel, the adjusting causing an increase in efficiency.

23. A method for monitoring distribution of a storage resource bandwidth as recited in claim 21, further comprising:
detecting a low efficiency; and
reassigning the portion of the total bandwidth assigned to the storage virtual channel, the reassigning causing an increase in efficiency.

24. A method for monitoring distribution of a storage resource bandwidth as recited in claim 21, wherein the total bandwidth capability includes a throughput capability and a response time capability.

25. A method for monitoring distribution of a storage resource bandwidth as recited in claim 24, wherein the throughput capability is measured in megabytes delivered per second and input/output requests performed per second.

26. A method for monitoring distribution of a storage resource bandwidth as recited in claim 21, wherein the assigned portion of the total bandwidth capability is based on a need and a privilege level of a client to which the storage virtual channel will serve.
